(19) United States
(12) Patent Application Publication
(10) Pub. No.: US 2011/0271937 A1
(43) Pub. Date: Nov. 10, 2011

(54) HEAT EXCHANGER METHOD AND APPARATUS FOR ENGINE EXHAUST GASES

(75) Inventors: Alexander Knafl, Anacortes, WA (US); Patrick G. Szymkowicz, Shelby Township, MI (US)

(73) Assignee: GM GLOBAL TECHNOLOGY OPERATIONS, INC., Detroit, MI (US)

(21) Appl. No.: 12/775,588

(22) Filed: May 7, 2010

(51) Int. Cl. F02M 25/07; B05D 7/22; F28D 15/00

(52) U.S. Cl. 123/568.12; 165/104.19; 427/230; 427/239; 427/237

(57) ABSTRACT

A heat exchanger device for an exhaust gas recirculation system of an internal combustion engine includes a heat exchange device including a first surface and a second surface. The first surface is in fluid contact with a recirculated portion of exhaust gas flowing in an exhaust system and the second surface is in fluid contact with a second fluid. The first surface is subjected to a surface treatment effective to reduce adhesive properties that relate to surface tension of particulate matter that precipitates from the recirculated portion of the exhaust gas.

### TECHNICAL FIELD

This disclosure relates to internal combustion engines, and more particularly to heat exchangers exposed to an exhaust gas feedstream of an internal combustion engine.

### BACKGROUND

The statements in this section merely provide background information related to the present disclosure and may not constitute prior art.

Internal combustion engines generate exhaust gas, including hydrocarbon (HC), carbon monoxide (CO), oxides of nitrogen (NOx), particulate matter (PM) and other emissions gases. An exhaust gas recirculation (EGR) system can be employed to reduce oxides of nitrogen (NOx) by diluting incoming air with recirculated exhaust gases which are inert, thus reducing peak combustion temperatures and correspondingly reducing NOx levels.

Combustion temperatures can be further reduced by cooling the recirculated exhaust gas, resulting in higher density recirculated exhaust gas. An EGR system can include a heat exchanger that cools the recirculating exhaust gas prior to entrance into the intake manifold. An EGR valve or other metering device may regulate the flow of the exhaust gas into the intake manifold.

A heat exchanger for use with an EGR system includes a plurality of heat exchange conduits constructed from thermally conductive material through which recirculating exhaust gas flows. The heat exchange conduits are in contact with a fluid, e.g., engine coolant or air that absorbs heat from the exhaust gas through the heat exchange conduit walls. Efficiency of heat transfer through the heat exchange conduit walls may be reduced when particulate matter (PM) precipitates and coagulates or otherwise deposits on the walls of the heat exchange conduits. Known exhaust gas systems including heat exchangers can include an oxidizing catalytic converter device upstream of an inlet of the heat exchanger for use with the EGR system to remove particulate matter (PM) from the exhaust gas feedstream to reduce loss of thermal efficiency caused by fouling, i.e., precipitation and deposition of particulate matter (PM) on the walls of the heat exchange conduits.

Design of a heat exchanger for an EGR system can include compensating for loss of thermal efficiency during its service life, including sizing the heat exchanger with excess heat transfer capacity to compensate for fouling that can occur during its service life. This excess heat transfer capacity can consume available packaging space, add weight, and affect overall design of the heat exchanger.

### SUMMARY

A heat exchanger device for an exhaust gas recirculation system of an internal combustion engine includes a heat exchange device including a first surface and a second surface. The first surface is in fluid contact with a recirculated portion of exhaust gas flowing in an exhaust system and the second surface is in fluid contact with a second fluid. The first surface is subjected to a surface treatment effective to reduce adhesive properties that relate to surface tension of particulate matter that precipitates from the recirculated portion of the exhaust gas.

### BRIEF DESCRIPTION OF THE DRAWINGS

One or more embodiments will now be described, by way of example, with reference to the accompanying drawings, in which:

FIG. 1 is a two-dimensional schematic diagram of an engine system including an internal combustion engine, a turbocharger and an exhaust system in accordance with the present disclosure; and

FIGS. 2A and 2B are two-dimensional schematic views including a side-view and an end-view of an axial-flow tube-type heat exchanger device in accordance with the present disclosure.

### DETAILED DESCRIPTION

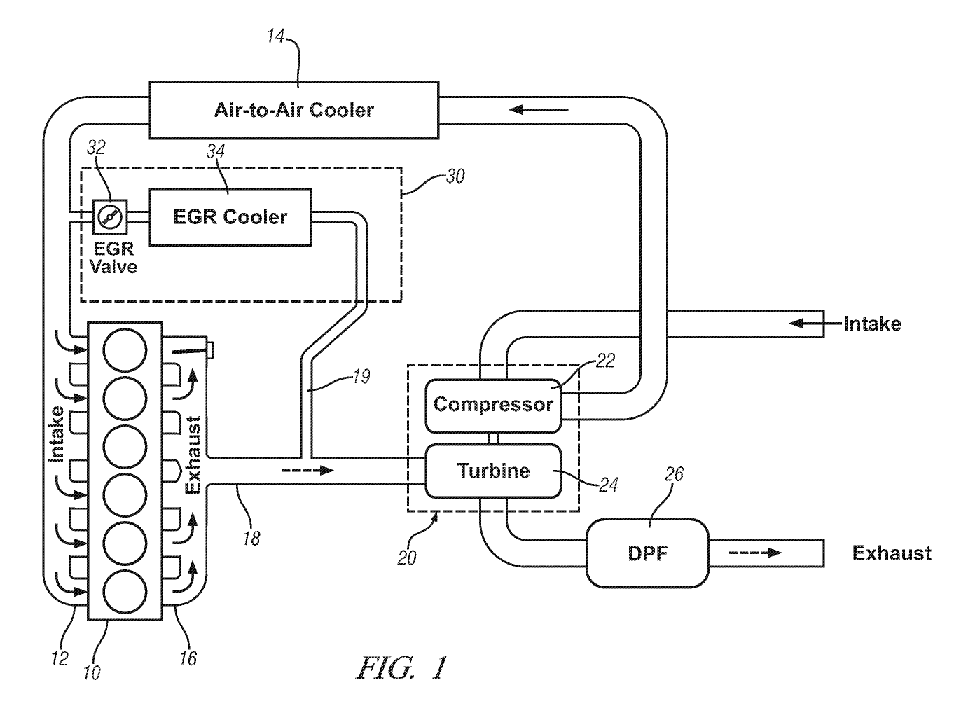

Referring now to the drawings, wherein the showings are for the purpose of illustrating certain exemplary embodiments only and not for the purpose of limiting the same, FIG. 1 illustrates an engine system including an internal combustion engine 10 including a turbocharger 20. The engine 10 is preferably configured to operate lean of stoichiometry. The engine includes an air intake system 12 and an exhaust system. The air intake system 12 includes, e.g., an intake manifold, an EGR inlet, and an air-to-air heat exchange device (Air-to-Air Cooler) 14 configured to cool intake air downstream of a compressor section 22 of the turbocharger 20. The exhaust system entrains exhaust gas output from the engine 10 and includes, e.g., an exhaust manifold 16, a downpipe 18, an EGR conduit 19, and an exhaust gas recirculation (EGR) system 30. Exhaust gas from the engine 10 flows into the exhaust manifold 16 through the downpipe 18 to a turbine section 24 of the turbocharger 20 and preferably passes through at least one exhaust aftertreatment device 26 prior to expulsion into atmospheric air.

The EGR conduit 19 directs a portion of the exhaust gas into the EGR system 30. In one embodiment, untreated exhaust gas flows from the engine 10 into the exhaust manifold 16 through the downpipe 18 with a portion of the exhaust gas flowing into the EGR conduit 19 to be recirculated into the intake system 12.

The EGR system 30 includes an EGR valve 32 downstream of a heat exchanger (EGR Cooler) 34. The EGR system 30 recirculates a portion of the exhaust gas to the intake system 12 of the engine 10, with the mass flowrate controlled by the EGR valve 32 in conjunction with engine operating conditions. The EGR system 30 as shown in FIG. 1 is configured as a high-pressure loop EGR system with the EGR conduit 19 fluidly connected to the downpipe 18 and upstream of the turbine section 24 of the turbocharger 20. Alternatively, the EGR system 30 can be configured as a low-pressure loop EGR system including an EGR conduit fluidly connected to the exhaust system downstream of the turbine section 24 of the turbocharger 20.

A control module controls opening and closing of the EGR valve 32 during engine operation to meter, i.e., control the mass flowrate of the recirculated portion of the exhaust gas into the intake system 12. The heat exchanger 34 is configured to transfer heat between the recirculated portion of the exhaust gas and a second fluid across the heat exchanger 34 and includes a plurality of cylindrical tubes encased in a housing in one embodiment. The cylindrical tubes of the heat exchanger 34 are formed from thermally conductive material, e.g., aluminum or stainless steel. A person having ordinary skill in the art will appreciate that the heat exchanger 34 may include any one of various heat exchanger configurations. For example, the heat exchanger 34 may include a tube-type, plate-type, shell-type, or other heat exchanger configurations using parallel-flow and counter-flow heat transfer methods.

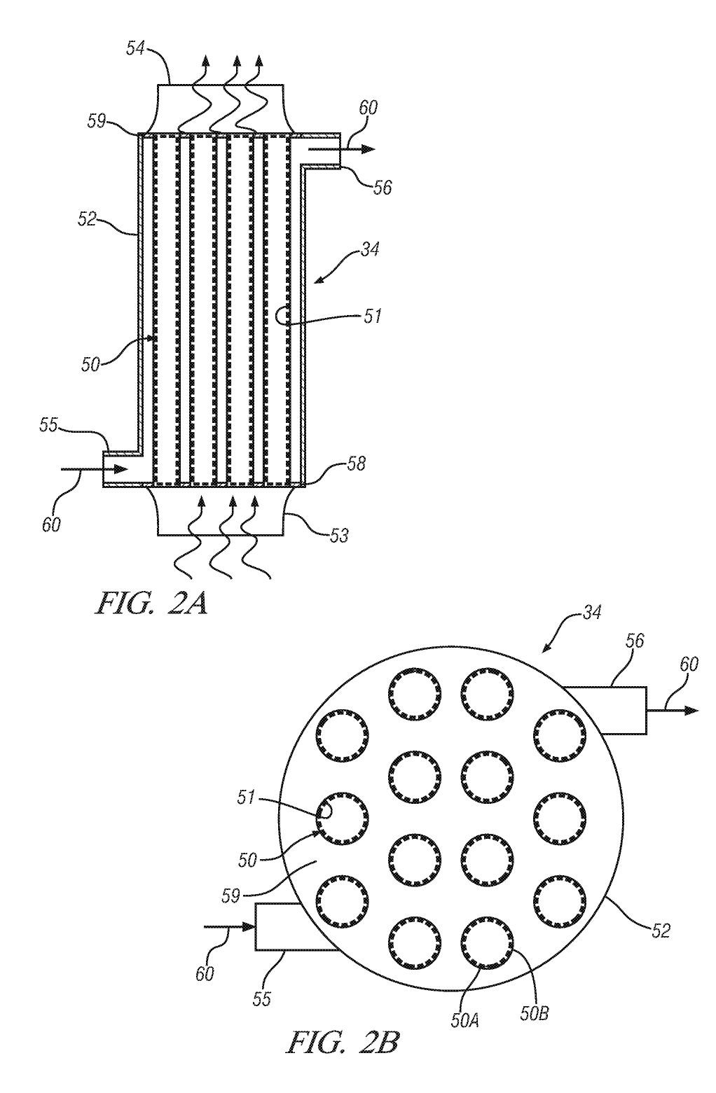

FIGS. 2A and 2B schematically show a side-view and an end-view of an exemplary embodiment of the heat exchanger 34, including an axial-flow tube-type heat exchanger including a plurality of heat exchange devices including cylindrical tubes 50 that function as fluidic conduits. The cylindrical tubes 50 are located in a housing 52. The tubes 50 are made from thermally conductive material. Each tube 50 has an inner surface 50A and an outer surface 50B. An exhaust gas path is formed through the heat exchanger 34 including an exhaust gas inlet 53 that is fluidly connected to the inner surface 50A of the tubes 50 that is fluidly connected to an exhaust gas outlet 54. The exhaust gas inlet 53 and the exhaust gas outlet 54 are preferably located at opposite ends of the heat exchanger 34. The tubes 50 are fluidly connected in a parallel arrangement resulting in concurrent fluidic flow of the recirculated portion of the exhaust gas through the inner surfaces 50A of all the tubes 50. Alternatively, the tubes 50 can be fluidly connected in a series arrangement resulting in serial fluidic flow of the recirculated portion of the exhaust gas through the inner surfaces 50A of the tubes 50. The housing 52 also includes a second fluid path including a second fluid inlet 55 and a second fluid outlet 56. An inlet plate 58 and outlet plate 59 may be positioned between the exhaust inlet opening 53 and housing 52 and between the housing 52 and the exhaust outlet opening 54, respectively. The second fluid inlet 55 and the second fluid outlet 56 are connected to a second fluid circulation system. The second fluid inlet 55 and second fluid outlet 56 define the second fluid path through the cylindrical housing 52 for the second fluid 60.

The recirculated portion of the exhaust gas flows through the exhaust gas path entering the heat exchanger 34 through the exhaust gas inlet 53, and flowing through the plurality of tubes 50 in fluidic contact with the inner surfaces 50A thereof, and exiting through the exhaust gas outlet 54.

The second fluid 60, e.g., ambient air or engine coolant, flows through the second fluid path contained within the housing 52 and fluidly contacts the outer surfaces 50B of the plurality of tubes 50. More specifically, the second fluid 60 enters the second fluid inlet 55, fluidly contacts the outer surfaces 50B of the tubes 50, and exits through the second fluid outlet 56. The inlet and outlet plates 58, 59 contain the second fluid 60 within the housing 52. Heat is exchanged in the heat exchanger 34 across the inner surfaces 50A and outer surfaces 50B of the plurality of tubes 50 between the recirculated portion of the exhaust gas and the second fluid 60.

In one embodiment, direction of flow of the recirculated portion of the exhaust gas is parallel to the direction of flow of the second fluid 60. In one embodiment, direction of flow of the recirculated portion of the exhaust gas is counter to the direction of flow of the second fluid 60.

Heat transfer through the heat exchanger 34 is a function of the temperature differential between the recirculated portion of the exhaust gas and the associated second fluid 60 between the inner and outer surfaces 50A and 50B, and the thermal efficiency of the heat exchange tubes 50.

The thermal efficiency of the heat exchange tubes 50 is affected by the presence of insulative materials that are deposited on the inner surface 50A. The insulative materials can include particulate matter (PM) including ash and soot, and unburned hydrocarbons. The insulative materials condense, precipitate, coagulate and otherwise deposit onto and adhere to the inner surface 50A of the heat exchange conduits 50. The thermal efficiency of the heat exchange tubes 50 reduces with an increased thickness of the insulative materials. The unburned hydrocarbons, particulate matter, and ash resulting from combustion are present in the exhaust gas feedstream in varying concentrations depending upon engine operating factors and ambient conditions. Magnitude of deposition of the insulative materials on the inner surfaces 50A of the heat exchanger 34 can be associated with factors including EGR mass flowrate and velocity, temperature and temperature gradient of the recirculated portion of the exhaust gas, and surface geometry of the inner surfaces 50A of the heat exchanger 34.

The inner surfaces 50A of the tubes 50 include treated surfaces that are subjected to a surface treatment 51. Preferably all of the inner surfaces 50A of all the tubes 50 are subjected to the surface treatment 51. The surface treatment 51 mitigates deposition onto the inner surfaces 50A of the heat exchanger 34 by delaying and preventing deposition and adhesion of particulate matter that precipitates out of the recirculated portion of the exhaust gas under some operating conditions. The surface treatment 51 facilitates evaporating and otherwise removing the deposited particulate matter, thus permitting recovery of thermal efficiency of the heat exchanger 34 under conditions where shear stress can physically remove the deposited particulate matter. Preferably the surface treatment mitigates deposition of the condensed particulate matter and facilitates evaporating and otherwise removing the deposited particulate matter by reducing and minimizing adhesive properties of the inner surface 50A that relate to surface tension of the particulate matter precipitating from the recirculated portion of the exhaust gas.

In one embodiment the surface treatment 51 includes coating the inner surfaces 50A with a nickel-based material using an electroless plating process to apply the material. In one embodiment the nickel-based material can include PTFE using an electroless plating process to apply the material. Electroless nickel plating is used to provide an even deposit across the entire inner surface 50A regardless of the physical geometry thereof. This includes cleaning the inner surface 50A by sequentially bathing the heat exchanger 34 in a base chemical bath and an acid chemical bath to remove unwanted soils. The inner surfaces 50A are preferably activated with a weak acid etch, or nickel strike. The nickel-based material is electrolessly applied, which includes a chemical reduction process that uses the catalytic reduction of nickel ions in an aqueous solution containing a chemical reducing agent to deposit the nickel metal without the use of electrical energy. The chemical reducing agent in solution is preferably uniform at all points on the inner surface 50A, said uniformity being accomplished by agitation to ensure a consistent concentration of metal ions and reducing agents.

In one embodiment the surface treatment 51 includes a low-friction material that is applied to the inner surface 50A using processes that include one of plating, coating, and spraying. In one embodiment the surface treatment 51 includes a diamond-like carbon coating that is applied to the inner surface 50A. An exemplary diamond-like carbon coating includes amorphous carbon (a-C) and hydrogenated amorphous carbon (a-C:H) films that are applied using physical vapor deposition processes by which the coating is simultaneously deposited over the complete inner surface 50A. The diamond-like carbon coating provides properties including high hardness, high resistivity, and dielectric optical properties. Another exemplary surface treatment applied to the inner surface 50A to minimize adhesive properties that relate to surface tension of particulate matter that precipitates from the recirculated portion of the exhaust gas includes a surface treatment that reduces surface energy, e.g., chromium nitride, molybdenum disulfide, and nickel-polymer composites. Another exemplary surface treatment applied to the inner surface 50A to minimize adhesive properties that relate to surface tension of particulate matter that precipitates from the recirculated portion of the exhaust gas includes reducing surface roughness of the inner surface 50A. Surface roughness can been reduced through physical processes like polishing, chemical processes like etching, thermal processes like heat treating, or applying surface coatings. Another exemplary surface treatment applied to the inner surface 50A to minimize adhesive properties that relate to surface tension of particulate matter that precipitates from the recirculated portion of the exhaust gas includes applying a non-stick material, e.g., material such as a fluorocarbon, a fluoropolymer and a fluorosilicone elastomer.

The use of the EGR system 30 including the heat exchanger 34 having inner surfaces 50A of the tubes 50 including treated surfaces that are subjected to a surface treatment 51 to mitigate deposition of particulate matter that precipitates out of the recirculated portion of the exhaust gas can eliminate a need for an oxidizing catalytic converter device upstream of an inlet of the heat exchanger to remove particulate matter (PM) from the exhaust gas feedstream to reduce loss of thermal efficiency caused by fouling.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A heat exchanger device for an exhaust gas recirculation system of an internal combustion engine, comprising:
a heat exchange device including a first surface and a second surface wherein the first surface is in fluid contact with a recirculated portion of exhaust gas flowing in an exhaust system and the second surface is in fluid contact with a second fluid; and
the first surface comprising a surface treatment effective to reduce adhesive properties that relate to surface tension of hydrocarbon molecules that precipitate from the recirculated portion of the exhaust gas.

2. The heat exchanger device of claim 1, wherein the surface treatment comprises a coating including a nickel-based material applied using an electroless plating process.

3. The heat exchanger device of claim 1, wherein the surface treatment comprises a diamond-like carbon coating applied using physical vapor deposition.

4. A method for maintaining thermal efficiency of a heat exchange device in an exhaust gas recirculation system of an internal combustion engine, comprising:
configuring the heat exchange device with a first surface and a second surface wherein the first surface is in fluid contact with a recirculated portion of exhaust gas flowing in the exhaust gas recirculation system and the second surface is in fluid contact with a second fluid; and
treating the first surface to reduce adhesive properties that relate to surface tension of particulate matter that precipitates from the recirculated portion of the exhaust gas.

5. The method of claim 4, wherein treating the first surface to reduce adhesive properties that relate to surface tension of particulate matter that precipitates from the recirculated portion of the exhaust gas comprises coating the first surface with a nickel-based material.

6. The method of claim 5, further comprising applying the nickel-based material applied using an electroless plating process.

7. The method of claim 4, wherein treating the first surface to reduce adhesive properties that relate to surface tension of particulate matter that precipitates from the recirculated portion of the exhaust gas comprises applying a diamond-like carbon coating to the first surface.

8. The method of claim 7, further comprising applying the diamond-like carbon coating using physical vapor deposition.

9. A method for maintaining thermal efficiency of a heat exchange device in an exhaust gas recirculation system of an internal combustion engine, comprising:
configuring the heat exchange device with a first surface and a second surface wherein the first surface is in fluid contact with a recirculated portion of exhaust gas flowing in the exhaust gas recirculation system and the second surface is in fluid contact with a second fluid; and
treating the first surface to mitigate deposition of particulate matter precipitated onto the first surface and facilitate evaporation thereof.

10. The method of claim 9, wherein treating the first surface to mitigate deposition of particulate matter precipitated onto the first surface and facilitate evaporation thereof comprises coating the first surface with a nickel-based material.

11. The method of claim 10, further comprising applying the nickel-based material applied using an electroless plating process.

12. The method of claim 9, wherein treating the first surface to mitigate deposition of particulate matter precipitated onto the first surface and facilitate evaporation thereof comprises applying a diamond-like carbon coating to the first surface.

13. The method of claim 12, further comprising applying the diamond-like carbon coating using physical vapor deposition.
